(19) United States
(12) Patent Application Publication
(10) Pub. No.: US 2009/0187928 A1
(43) Pub. Date: Jul. 23, 2009

(54) Primary Application Advertising Layer

(75) Inventor: Manuel Mark, Fortaleza (BR)

Correspondence Address: Rextide, Inc, 9663 Santa Monica Blvd., #444, Beverly Hills, CA, 90210-4303, US

(73) Assignee: REXTIDE INC., Beverly Hills, CA (US)

(21) Appl. No.: 12/255,679

(22) Filed: Oct. 22, 2008

Related U.S. Application Data
(60) Provisional application No. 60/981,636, filed on Oct. 22, 2007.

(51) Int. Cl. G06F 9/44; G06F 3/048

(52) U.S. Cl. 719/329; 715/808

(57) ABSTRACT

The present invention relates to a method that allows master web applications integrated into web slave applications to advertise products or services overcoming limitations related to the reduced advertising space available in the master application. The method also allows users to avoid disruption problems when working simultaneously with master and slave applications.

### CROSS-REFERENCE TO RELATED APPLICATIONS

This application claims priority from U.S. Provisional Patent Application Ser. No. 60/981,636, filed on 22 Oct. 2007 and entitled “Primary Application Advertising Layer” the contents of which are hereby fully incorporated by reference.

### BACKGROUND OF THE INVENTION

1. Field of the Invention

The present invention relates to the field of digital advertising.

2. Description of the Related Art

In the last years, web programmers have developed different methods to allow the integration or embodiment of a web application into another. One of the reasons for such developments is to avoid the disruption problem that Internet users face when browsing among different websites. The disruption problem occurs when users open different applications and instead of remaining on the initially visited website are redirected to different websites. Consequently, users usually forget the content of the first visited web page or even the originally objective of the Internet session. On the other hand, users are oft overwhelmed by the amount of information presented by websites which includes not only website content itself but also advertisement.

Contrarily, when a master application is integrated into the website of a slave application, the user remains in the first opened application (slave application). This allows for avoiding or reducing the problem mentioned above. However, due to this integration, master applications notably limit the amount of information displayed to the user when integrated into a slave application. In addition to this initial reduction, the larger the number of master applications integrated into the slave application, the less the space available in the website of the slave application. This leads to the lost of advertising opportunities for the master applications as they have to limit the information showed to the minimum necessary for performing the application functions.

Thus, there is a need for creating new digital advertising methods that eliminate such disadvantages. Therefore, the present method allows master applications to be integrated into slave applications without limiting its capacity to advertise products or services to their users.

### DETAILED DESCRIPTION OF THE INVENTION

The present invention generally relates to a method that allows master web applications (hereafter: master applications) integrated into slave web applications (hereafter: slave applications) to advertise products or services in a way that problems regarding the limited advertising space available in master applications are overcome. In addition to this, the method allows users to avoid disruption problems when working simultaneously with master and slave applications. In this specification the term master application refers to internet web applications that are integrated into the website of a slave application by displaying a small frame on the website of the latter that allows to perform basic or main functions of the master application. The slave application displays the small frame (hereafter: the “master frame”) containing the master application within its website. This allows for using the master application in the website of the slave application without abandoning the latter.

When the user performs certain actions in the master frame of the master application, the method allows for displaying a “pop-up” window (the window) that is superimposed in front of the website of the slave application. This window contains a notification that the latest operation performed by the user has been successfully completed. The window is of a size that allows for displaying advertising content in addition to this notification.

In a preferred embodiment, the method is used in Dayboox.com., (hereafter also referred as to “the website”) a web service that allows users to create a digital journal. The user input to the website information relating to past life-events with the desired regularity. This information is organized in a way that allows for creating a digital journal. In doing so, events occurred in user's life are tracked on the website where they remain indefinitely stored. Information provided by the user for creating the digital journal may comprise any kind of electronic files, like but not limited to, music, videos, images, and photos.

Dayboox may partnership in order to offer its services in a master frame integrated into the website of another web service i.e. facebook.com (facebook). In this case, Dayboox is the master application whose master frame is embedded on the web interface of a slave application called facebook. When the user logs into Dayboox through the master frame integrated into facebook, Dayboox receives, distributes, organizes, and stores the content input or uploaded by the user. The master frame is displayed on the website of facebook where the user perform any of the desired actions. The method allows for recognizing user actions relating to the conclusion of tasks in relation with any of the master application functions. By way of example only, every time when the user uploads a file to the master application i.e. a picture; a window is displayed to notify the user that the file was successfully uploaded. For purposes of the present invention, the term “window” means a “pop-up” window that displays information related to the conclusion of a task by a master application. It also includes advertisement within the information displayed. This window is superimposed in front of the opened page of the website of the slave application.

When the confirmation window is displayed, the user may choice between closing it or waiting until it closes automatically. The advertiser may decide the time limit that the confirmation window is superimposed in front of the web interface of the slave application. It should be noted again that the displayed advertisement is complementary to the task confirmation, which avoids or reduces the disruption problem explained above.

Every time a user clicks on a determined ad, patterns and preferences are mined from the navigation data to be used in the generation of new related advertisement. By way of example only, if the user clicks on an ad regarding surf bathing suits, the method allows for generating advertisements or listings regarding similar or related products like surfboards or suntan creams.

The method allows for automatically offering new-targeted ads or listings to new potential advertisers. More specifically, on the one hand, the method allows for automatically sending related ads to users from an advertiser previously registered to the master application. On the other hand, when the related products or services belong to an entity not registered to the master application, advertising content is offered to such entity for being displayed in the main website of the master application.

The method also allows for automatically generating advertisement regarding related products but not similar or competing products. In the example above, the method automatically recognizes any surf bathing suits as a competing product. Upon payment of an extra fee, the advertiser may dispose a ban on advertising any competing product of its product in the website.

The advertising content resulting from the web mining explained above is displayed on the main website of the master application. In this way, this new-targeted advertisement is displayed as soon as the user is in the website of the master application, in which the advertiser has more advertising space to show their products or services.

This allows for compensating the limitations of advertising on master applications when embodied into slave applications. On the other hand, the method allows for displaying in the main website of the master application only targeted ads so that the advertising space is better employed.

It should be understood that the above-mentioned web services have been used by the way of example only and that the scope of the invention should not be limited by the described exemplary embodiment.

What is claimed is:

1. A method of advertising in a web master application integrated within a slave application, comprising the steps of:
a) integrating the master application into the slave application;
b) identifying user's actions related to the conclusion of tasks in the web master application, wherein a conclusion command is generated after identification of said actions;
c) generating a pop-up window, said pop-up window generated upon receipt of the conclusion command, said pop-up window containing advertisement and a notification of successful conclusion of said action; said pop-up window consisting of text-only, graphics-only or a combination of both;
d) displaying said pop-up window in front of the website of the slave application;
e) storing data related to advertisements opened by the user, said data being mined to generate targeted ads of related products or services; and;
f) displaying said targeted ads on the main website of the master application;

2. The method of claim 1, wherein letter (e) further includes the automatic recognition of competing products, said competing products being excluded as content for new targeted ads upon request of the advertiser.

3. A method of advertising in a web master application integrated within a slave application, comprising the steps of:
a) integrating the master application into the slave application;
b) identifying user's actions related to the conclusion of tasks in the web master application, wherein a conclusion command is generated after identification of said actions;
c) generating a pop-up window, said pop-up window generated upon receipt of the conclusion command, said pop-up window containing advertisement and a notification of successful conclusion of said action; said pop-up window consisting of text-only, graphics-only or a combination of both;
d) displaying said pop-up window in front of the website of the slave application;
e) mining the data identifying advertisements opened by the user to generate listings of related products or services;
f) offering such listings to the provider of said products or services; and;
g) displaying said listings on the main website of the master application upon payment by the provider.
